(19) United States
(12) Patent Application Publication
(10) Pub. No.: US 2017/0161991 A1
(43) Pub. Date: Jun. 8, 2017

(54) System and method for public verification of a gambling website or gaming event

(71) Applicants: Aryo Ayati, Rockville, MD (US); Aram Hessami, Charles Town, WV (US)

(72) Inventors: Aryo Ayati, Rockville, MD (US); Aram Hessami, Charles Town, WV (US)

(21) Appl. No.: 14/956,509

(22) Filed: Dec. 2, 2015

(51) Int. Cl. G07F 17/32

(52) U.S. Cl. CPC G07F 17/3244; G07F 17/3293; G07F 17/3241

(57) ABSTRACT

In one example, we describe a method and system to solve the following problem for on-line gambling industry or gaming or on-line software or entertainment, which has to deal with two significant issues, as examples: (1) The integrity of the cards, the dice, or any random event generator; and (2) The possibility of cheating. On the first problem, the question is how would one know that the cards are not stacked to either favor the house/dealer in the case of Blackjack, or in the case of poker, the cards are not stacked as to favor betting and increasing the size of the pot and the rake. We have developed a software platform that delivers secure, encrypted cards, or other random seed generated event game, through a process that makes it virtually impossible for the integrity of the game to be compromised without detection. More variations and examples are discussed here.

### BACKGROUND OF THE INVENTION

The gambling and gaming industry, especially online versions, have become even more popular recently. So, there is a considerable amount of money spent and used on those sites and activities. Thus, there is a lot of fraud or potential for fraud in this environment. Or, at least, the people playing on those sites or governments want to make sure this does not happen, or minimize that, as much as possible. For example, and in particular, people want to make sure that the business is legitimate and fair to all players, or the website does not tilt or bias the odds of winning or losing in its own favor (the house or casino's favor) or a third party's (accomplice) favor. Thus, everything has to be transparent and verifiable for all parties and public and governments and all players. Otherwise, without a good trust or method of verification and without a clear transparency and unbiased confirmation, the people lose the trust and abandon the game. Thus, the industry will suffer drastically. Therefore, it is paramount that the gaming or casino or online industry self-regulate and police itself properly with proper tools and methods.

The invention here addresses exactly the same problem mentioned above, for which nobody has a complete solution, yet. We provide a method and apparatus for verification and confirmation, for validity and legitimacy of the online business, gambling, wagering, casino, fantasy sports, any type of racing, social gaming, bingo, sports betting, horse racing, car racing, simulation, software game, game device, game app, mobile device game, phone game, virtual game, virtual reality, 3D game, or the like, for fairness and peace of mind, which encourages and increases growth, e-commerce, transactions, participations, and repeat customers.

However, the invention and embodiments described here, below, have not been addressed or presented, in any prior art.

### SUMMARY OF THE INVENTION

The problem we address here is that the on-line gambling industry has to deal with two significant issues:

1. The integrity of the cards, the dice, etc., and

2. The possibility of cheating

On the first problem, the question is how would one know that the cards are not stacked to either favor the house/dealer in the case of Blackjack, or in the case of poker, the cards are not stacked as to favor betting and increasing the size of the pot and the rake.

The second problem has to do with hackers who would know the cards before the cards are dealt or during the game. This is not to imply that these are the only ways of cheating, but these two problems are examples of what our invention would solve, at the minimum.

The solution, as one embodiment: We have developed a software platform that delivers secure, encrypted cards to various games through a process that will make it virtually impossible for the integrity of the cards or dice to be compromised without detection. More variations and examples or embodiments are discussed below.

### BRIEF DESCRIPTION OF THE DRAWINGS

FIG. 1 is for one embodiment, as an example, for method of invention, with shuffling.

FIG. 2 is for one embodiment, as an example, for method of invention, with SSS software.

FIG. 3 is for one embodiment, as an example, for method of invention, with SSS software, continued from FIG. 2.

FIG. 4 is for one embodiment, as an example, for method of invention, with shuffling.

FIG. 5 is for one embodiment, as an example, for system of invention, with auditing.

FIG. 6 is for one embodiment, as an example, for system of invention, with verification.

FIG. 7 is for one embodiment, as an example, for system of invention, with predetermined time or other conditions.

FIG. 8 is for one embodiment, as an example, for system of invention, with subscriber services.

FIG. 9 is for one embodiment, as an example, for system of invention, with subscriber secure shuffle service request.

FIG. 10 is for one embodiment, as an example, for system of invention, with SSS providing service response.

FIG. 11 is for one embodiment, as an example, for system of invention, with public services.

FIG. 12 is for one embodiment, as an example, for system of invention, with verifiability.

FIG. 13 is for one embodiment, as an example, for system of invention, with transparency.

FIG. 14 is for one embodiment, as an example, for system of invention, with accountability.

FIG. 15 is for one embodiment, as an example, for system of invention, with replay and simulation features.

### DETAILED DESCRIPTION OF THE PREFERRED EMBODIMENTS

Here is the step-by-step process, as one embodiment:

Our software, called SSS (for Secure Shuffle Software or Secure Shuffle Service):

1. Creates a virtual factory that produces playing cards for every game (or dice or any random event or outcome for any game or gambling event).

2. Encrypts the cards in the database so that they are totally unreadable and thus unknown even to a hacker.

3. Verifies the subscriber's request, an on-line casino, which is ordering a deck of cards for a particular game for a particular table in a particular casino.

4. Interfaces with the Casino's existing software, reading the casino's game and table specific data.

5. Sends a virtual token to the subscriber asking to use an encryption “key” provided by us, so that we can use this “key” to decrypt the casino's information, making sure that the requester is the same, to whom that we had issued a specific encryption “key.”

6. Encrypts all these communication line items, as well.

7. Starts shuffling the cards according to our algorithm.

8. Time-stamps the deck and attaches the pertinent information to that deck.

9. We block-chain the cards and all the associated information for extra security, such that no one, including the SSS, can change anything without changing everything which in this case is millions of lines.

10. Sends the deck to the subscriber.

11. Provides the subscriber a key to decrypts the cards and starts dealing.

12. Stores all the information in our data warehouse.

13. And finally, places the entire deck in the same order online for all to see and verify, making sure they were dealt the cards they were supposed to receive based upon that randomized and encrypted cards provided to the casino.

We can also use PKI for public and private keys and signatures for verifications. The whole sequence mentioned above for all block chain data is also available for verification by a third party or government auditor, for all cases or at random cases, to check the integrity of our work. This sequence can also be hashed as a single number or code for verification, with a small chance of repeat number or code, for certainty of the results. Again, the hash number can also be stored or verified by a third party or auditor or government agency or casino/gambling authority or commission or agency or inspector.

We have used the following to develop our software: Java, MySQL, Micro Strategy, Open Source, and Front Accounting, as an example.

In order to bring even more transparency and accountability, and thus, build trust for the players to continue playing, SSS adds another layer of “checks & balances” by having a third party reputable accounting firm or an insurance company be the overseer and the inspector of our software and operation, and even can insure each deck of cards against foul play, as an insurance entity or offered by another entity.

This measure will add a great deal of confidence to the industry, and this process in its entirety separates the card supplier from the casino, and even the software company, which handles the dealing of the cards and each game.

The ultimate check, however, is for the players, who will be able to go to our website and check the cards that were played in that casino at that particular table. The player can even play out the entire hand by filling in the number of players at the table and his own seat in relation to the dealer at that table, to simulate the game independently for verification. That gives an ultimate certification and peace of mind for the players against any possibility of the casino's systematic cheating. The whole industry and public would benefit from our assurances and safeguards, with verifiable techniques and outcomes.

This can be used for any other random or semi-random generator for the games, e.g., using a seed value for generation, e.g., with a formula or function based on the seed, such as for dice or coin flip or card games or slot machines, or for fantasy sports or odds on a game or sport event or racing cars or horses or the like, for one or more numbers or codes or sets of values or objects, on a physical or virtual or simulated machines or devices or pads or computers or smart phones, such as for poker or fantasy sports or casino devices, e.g., Wheel of Fortune game on PC or smart phone or slot machine, as real or simulated version, as software.

In one embodiment, we describe a method for poker or other card games, to generate the entire stack of cards shuffled and randomized. In one embodiment, we have randomization plus encryption plus shuffle plus package, sent to the dealer or casino or game console or machine or smart phone or computer or computing machine. In one embodiment, we have a reputable auditor or company checking our work with stamp of approvals, periodically or at sessions or always or randomly or spot-check or at a request or any other formulas or schedules. Or, it can be done by government or international organizations approved or trusted by public or people.

In one embodiment, we present to the public on Internet or network, accessible to all people, to visit and check for themselves, regarding a set of random numbers or events or cards or dice or coin or game parameters or the like, the validity and confirmation for those, within a short amount of time after the live event or game, e.g., 10 minutes later, to make sure that no cheating or setup was done by/from the game organizer or casino or web site owner/operator.

In one embodiment, we have e.g. casino 5, table 4, or game 3, at 5:30 pm local time, as set/chosen by verifying public or person, to verify the game, casino, device, or website, shortly after the game, e.g., with all cards shown or sequence or set, for poker game, as they come up in the game, to replay the game or simulate to make sure that the randomness and fairness were obeyed and legitimate, for all players and all games, all the time.

In one embodiment, we have a file sent to the user immediately during live game, for all random events and parameters captured for the game. However, the user or player (or government or agent or trusted third party or repository) cannot open the file during the game in real time, but holds on the file for safekeeping. And after the game is over, the user is sent a key or code to open the file, and view its content which has all the parameters used on that game, to verify the randomness in advance, to show the fairness and complete verification, as the file was obtained at the beginning, and thus, it could not have been changed anymore, to fit the potential cheater's sequence or set or values or cards or parameters. So, the matched data confirms that the data were never changed, as original data, and the randomness was legitimate, for fair game for all players. Basically, if there were no matching, then it is concluded that the game was rigged, fixed, or manipulated, for all to see and understand. So, it is impossible to cheat the system this way by casino or game owner or operator. Thus, the system brings confidence and reliability for the industry and casinos or websites.

In one embodiment, we have 100 percent randomness plus encrypted plus fast delivery and release, to avoid hacking, plus open up for verification for public to see/verify/confirm the legitimacy of the game and operation.

In one embodiment, we have e.g. 1 to 5 cents charged for a deck of card randomized and prepared, for use for a poker, or other parameters for other games, or other card games, paid by casino to obtain from us.

In one embodiment, we have advertisements for the website that we have. In one embodiment, we have a teaching tool to play games such as poker, for public later on, e.g. redoing or replaying the games, or simulating, or real game replayed by famous players, or as interactive with novice public players, to play and learn from masters or others through our website. We can charge money for teaching or demo or view, or show ads as source of income for our website. This is entertaining and instructive and fun. It can capture the videos on Youtube-style sites, as well, for view.

In one embodiment, we have degrees and levels of players, e.g. master level, for incentive to play, or follow the best players, with scores for expertise or skills, e.g. in poker and other games.

In one embodiment, e.g., we have time stamps for ordering the shuffled deck of cards, for starting point or time, then capture all the cards, with corresponding time stamps, at the end or step-by-step or at each stage. In one embodiment, e.g., we have encryption, then put it in a shell, then use private key, then send it to many users, with a time stamp. In one embodiment, e.g., we keep the file for verification of parameters later, by authorized people or any person.

In one embodiment, e.g., we have the parameters in a file stored for future inspection by others, kept at a 3^{rd} party location or storage, which is trusted by public. In one embodiment, e.g., we have the process insured by a third party entity, against risks and breach. In one embodiment, e.g., we have a copy of the files given to the government or an unbiased entity for random inspection and verification, for public release.

In one embodiment, our invention, Secure Shuffle Services (SSS), is providing two general types of services: one to the casinos and service subscribers, such as websites, and the other one to the public, in general. The combination of these two services alleviates or substantially reduces the possibility of all types of cheating (except collusion).

Here are the features of the services, as one embodiment:
I. Subscriber Services
   1) Enroll subscribers
      a. Set up subscriber profile
         i. Name & demographics
         ii. key exchange (encryption public key)
      b. Set up subscriber's Accounting
         i. Billing format
         ii. Invoicing
   2) Subscriber Secure Shuffle Service Request
      a. SSS is exposed to Subscribers as an Application Protocol Interface (API)
      b. Subscriber passes the following input parameters to the Service/API
         i. Subscriber Identifier
         ii. Public Key verification
         iii. Secret Pass Phrase
         iv. Subscriber URL
         v. Table Number
         vi. Game-type
         vii. Hand Number
         viii. The combination of Hand number, Table Number & Subscriber ID must be unique
   3) SSS provides a service response by:
      a. Unique Deck of Cards created based on the game-type
      b. Encrypt the Cards in database
      c. Shuffling the cards using e.g. Modern Fisher-Yeats Algorithm
         i. Fisher-Yeats for shuffling a deck of cards requires 51 random numbers
         ii. Using Cryptographic Random number generation SSS database creating 51 Pseudo Random Numbers. A seed of one pseudo random number is used to pick from a list of set of pseudo random numbers.
      d. Time-stamp the Shuffled deck
      e. Storing it to the database with all appropriated data
      f. Block-chain it
      g. Send the shuffled, encrypted and block-chained Cards as the Service Response
II. Public Services
   1. Verifiability
      a. Subscriber's Table Information is stored and linked to the Cards
      b. The shuffled, encrypted and block-chained cards (SEBC) are stored
      c. The time and the duration of the delivery and Casino's time of access/use is stored
      d. Any player or a dealer can recreate each game to the end
   2. Transparency
      a. Every SEBC is displayed in SSS publicly accessible website.
      b. The Website allows anyone to recreate the initial flop
      c. The Order of the SEBC will be available.
      d. The Casino can set the release time of the information from 1 to N minute after the deal
   3. Accountability
      a. Anyone will have access and can trace his/her own initial cards
      b. Since you cannot change anything without changing everything, similar to hash function, SSS and the players will know if the cards are compromised during or before the deal.

In addition to SSS auditors, e.g., there is a third party, a world-famous accounting firm, to audit and verify the entire process.

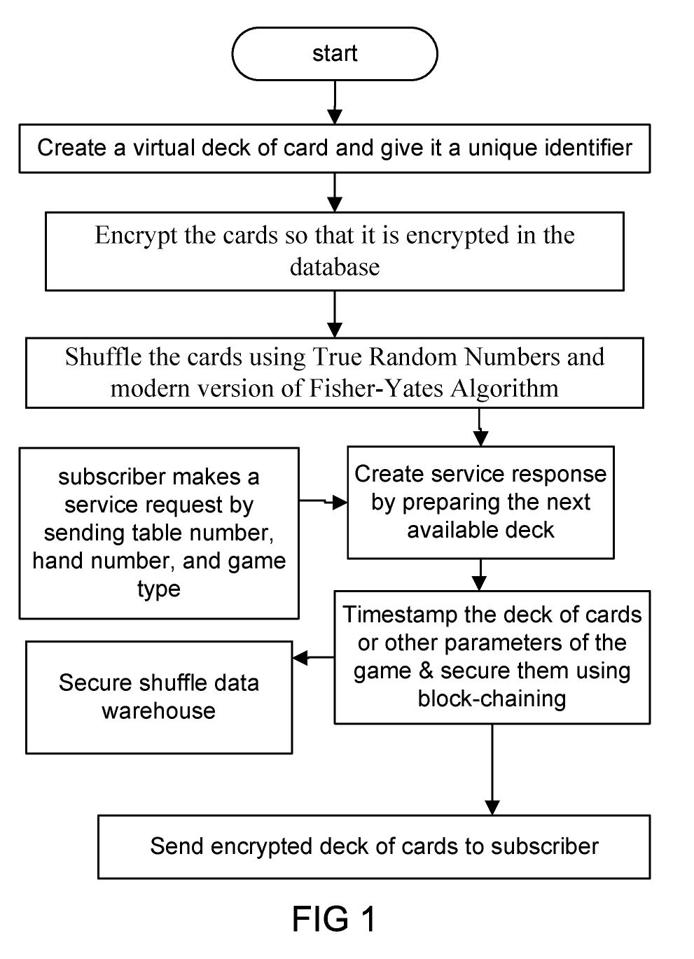

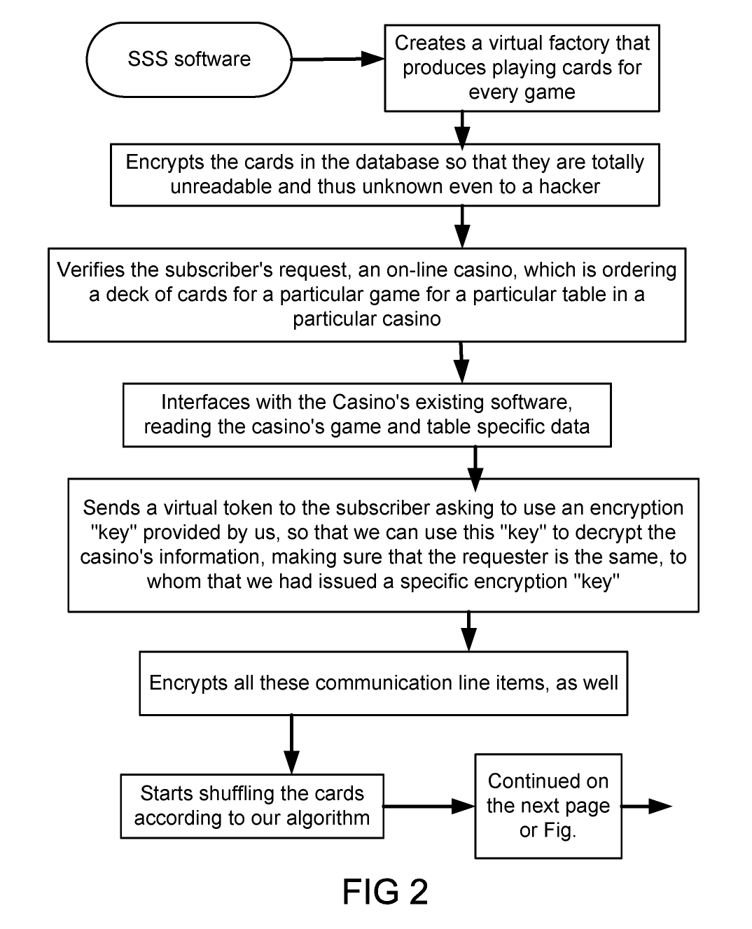

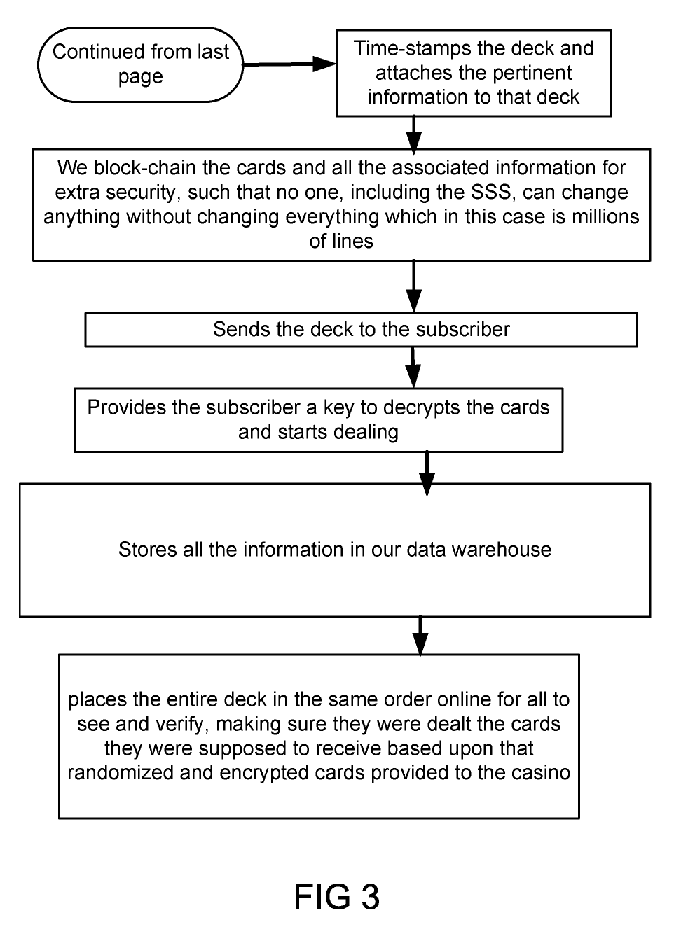

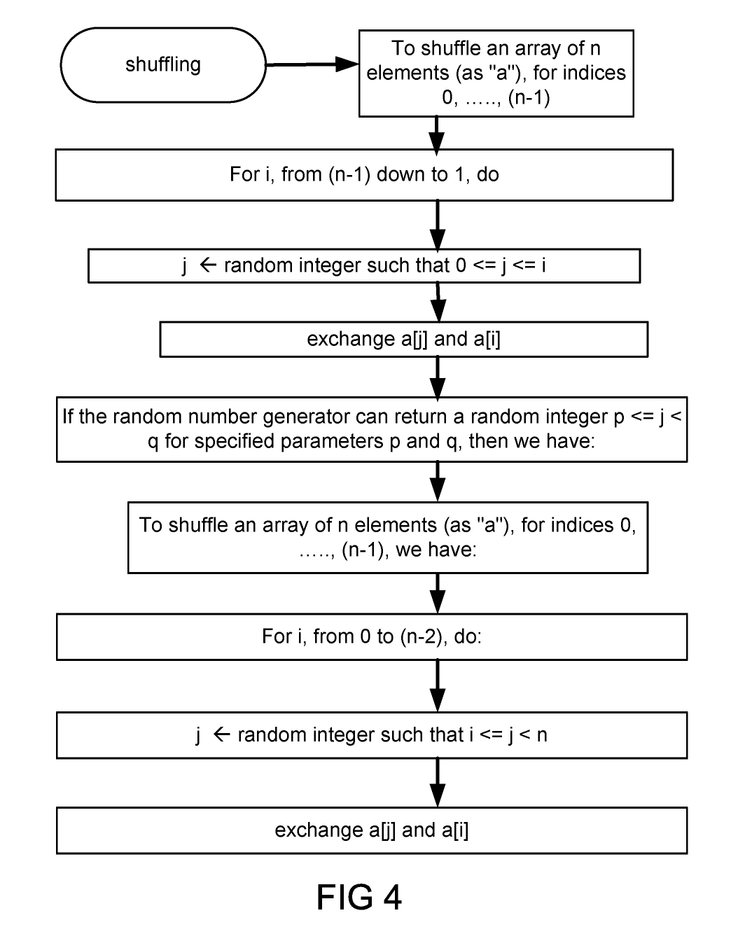

FIG. 1 is for one embodiment, as an example, for method of invention, with shuffling. FIG. 2 is for one embodiment, as an example, for method of invention, with SSS software. FIG. 3 is for one embodiment, as an example, for method of invention, with SSS software, continued from FIG. 2. FIG. 4 is for one embodiment, as an example, for method of invention, with shuffling.

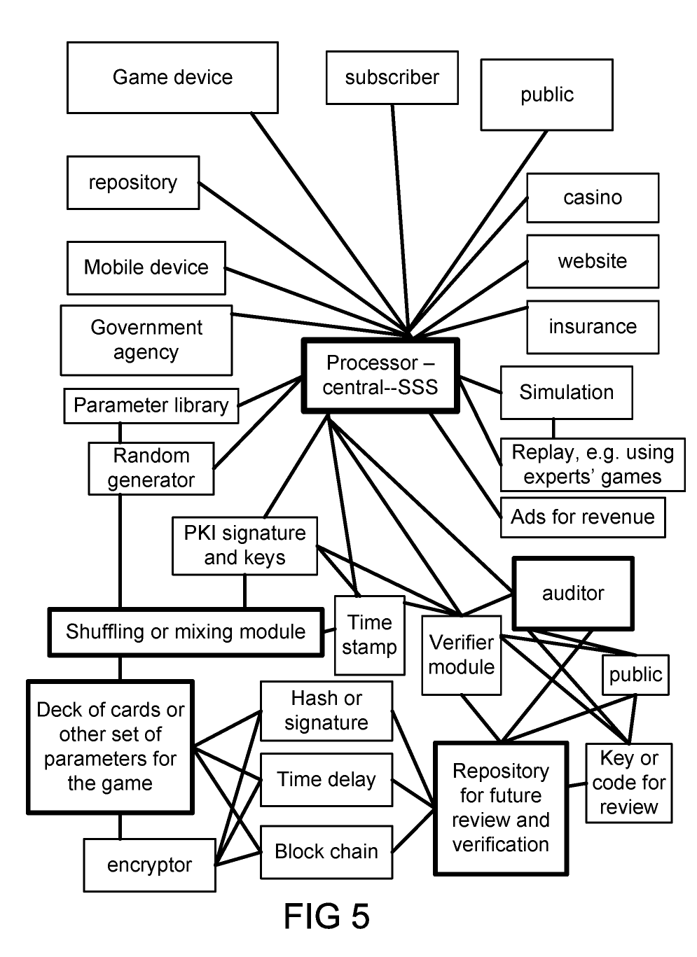

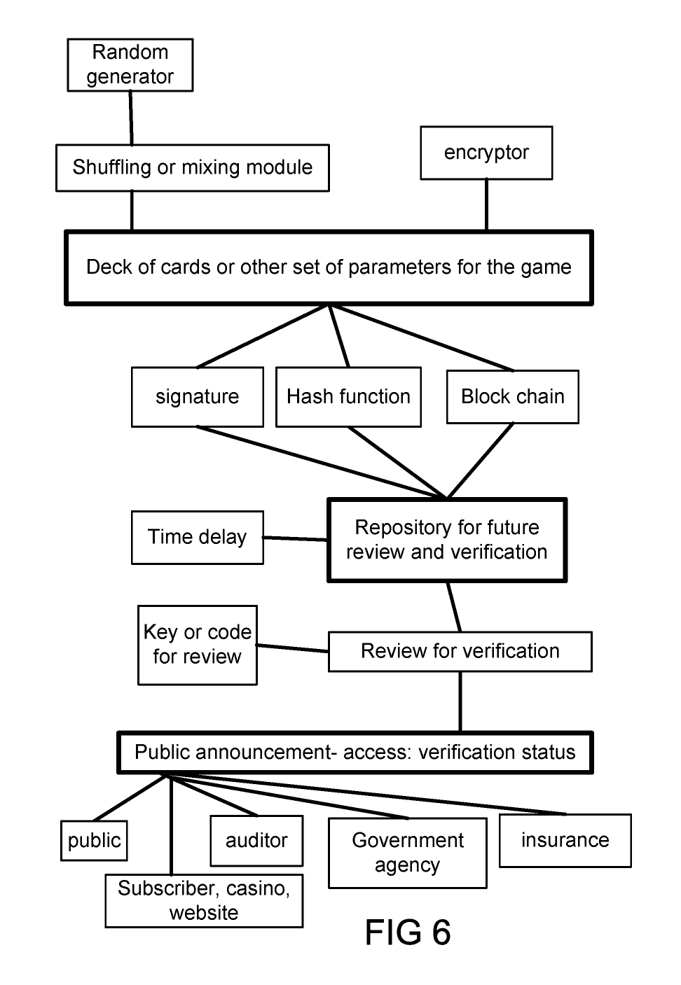

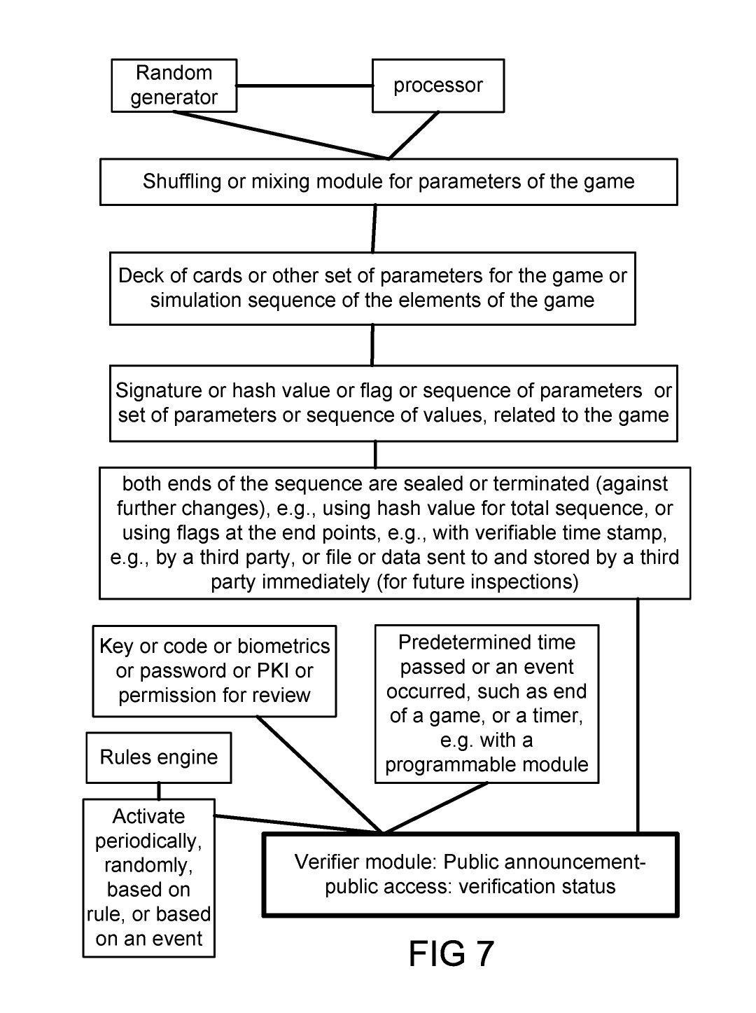

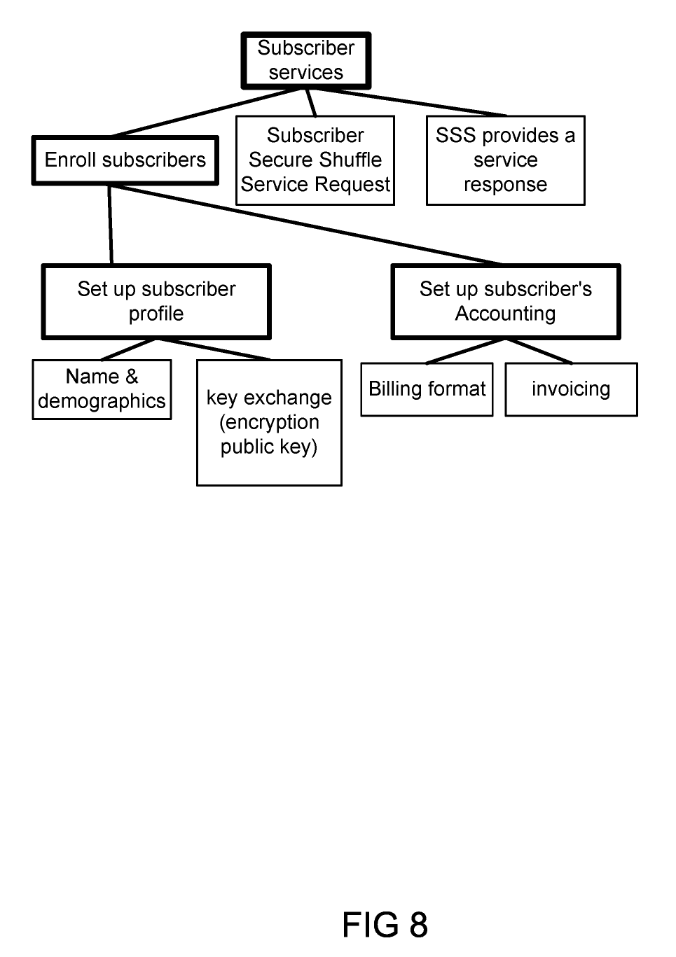

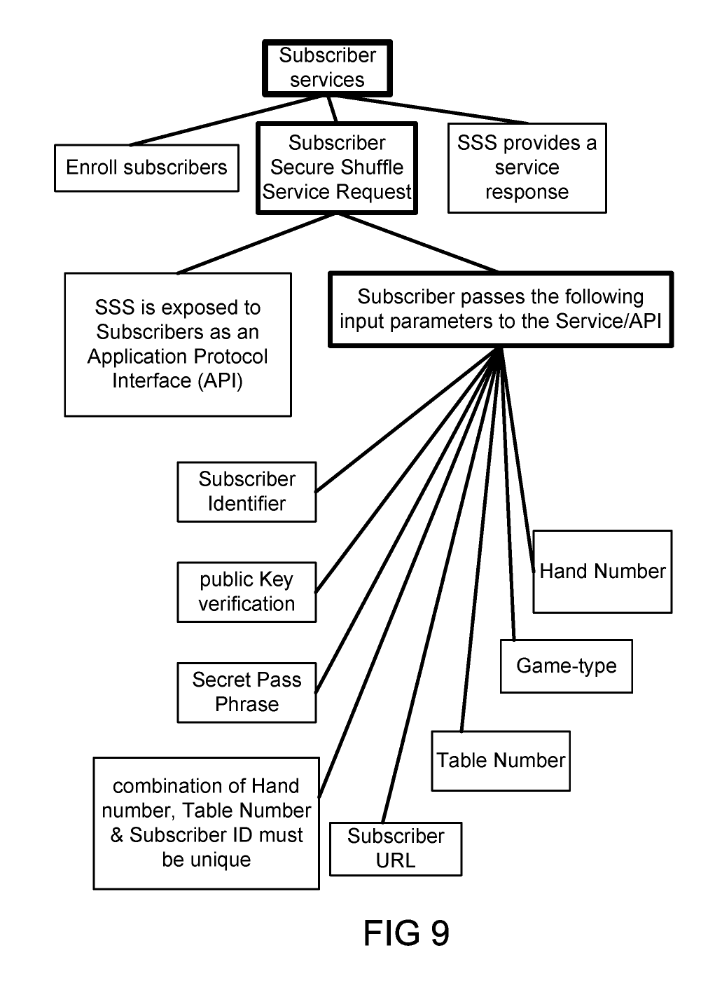

FIG. 5 is for one embodiment, as an example, for system of invention, with auditing. FIG. 6 is for one embodiment, as an example, for system of invention, with verification. FIG. 7 is for one embodiment, as an example, for system of invention, with predetermined time or other conditions. FIG. 8 is for one embodiment, as an example, for system of invention, with subscriber services. FIG. 9 is for one embodiment, as an example, for system of invention, with subscriber secure shuffle service request.

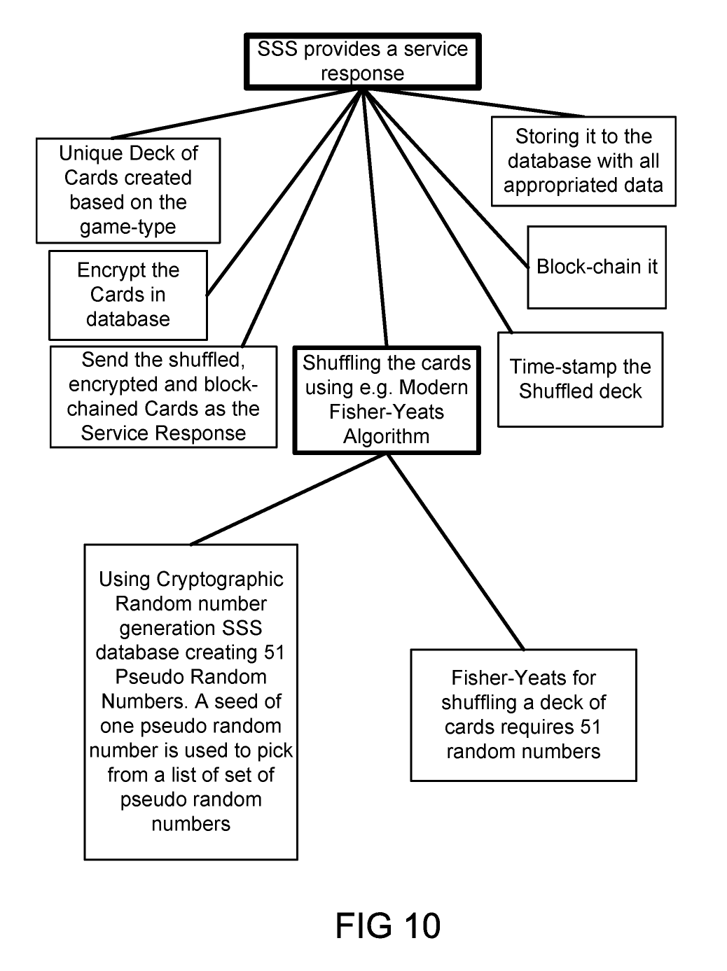

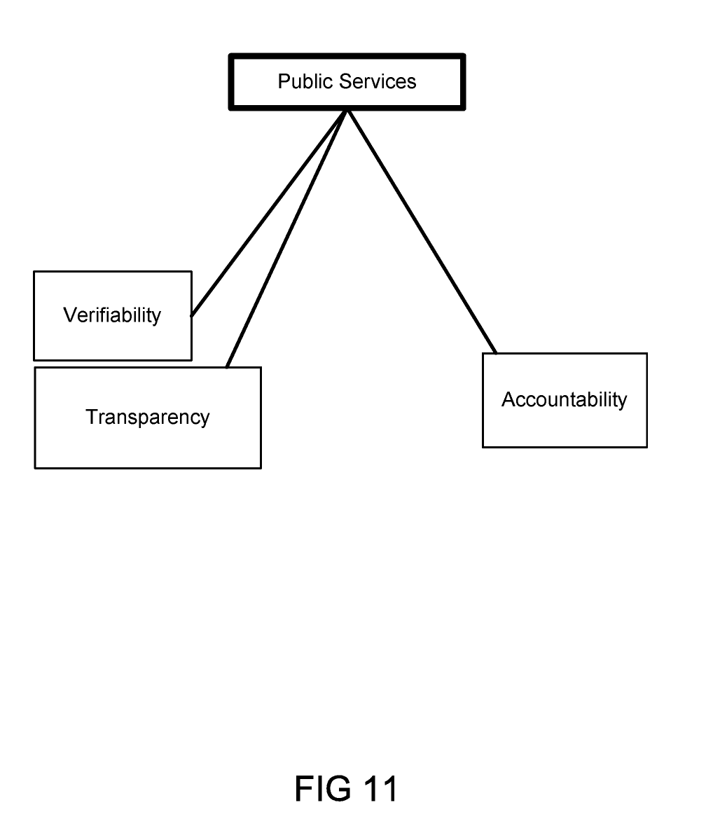

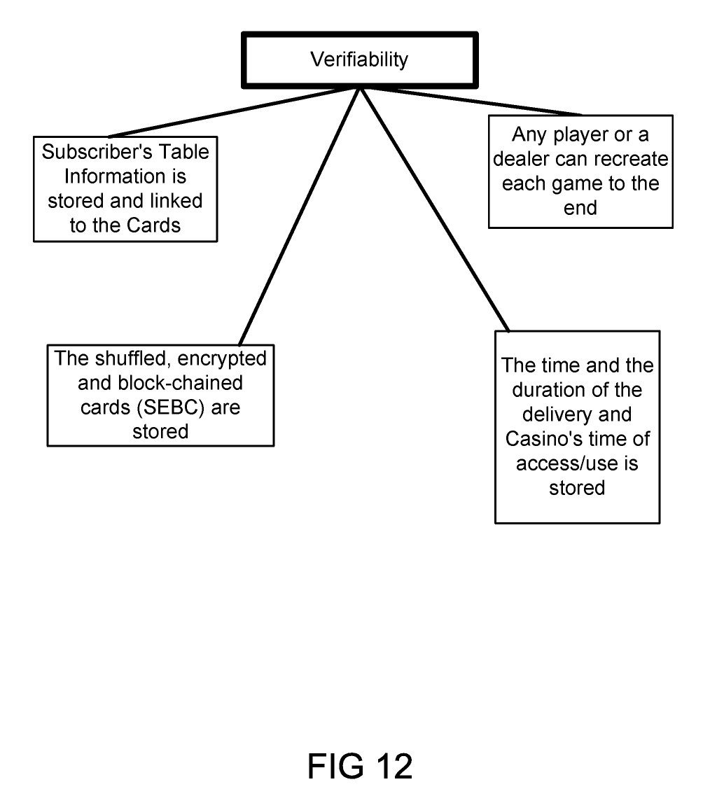

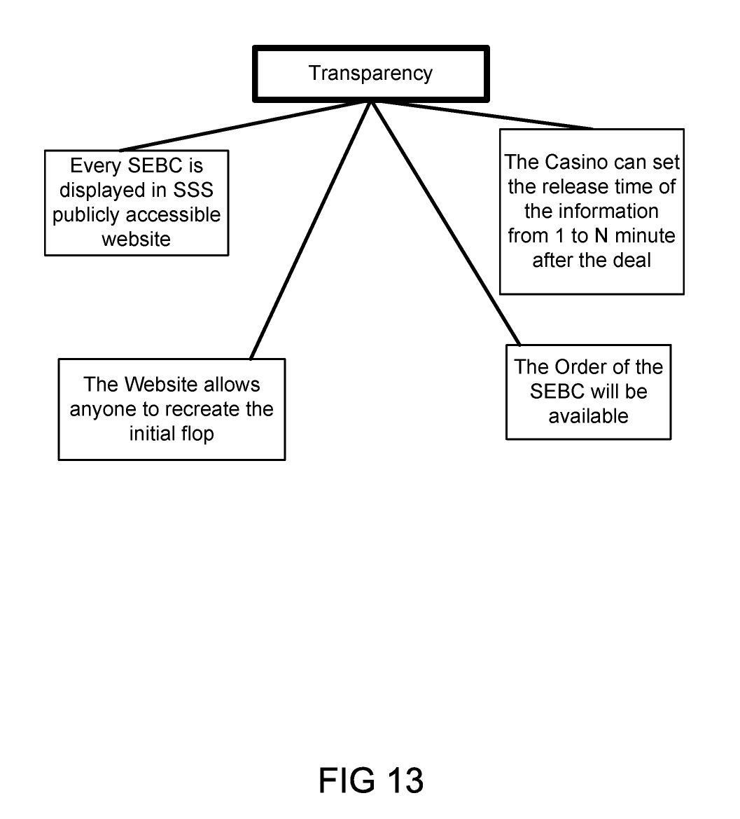

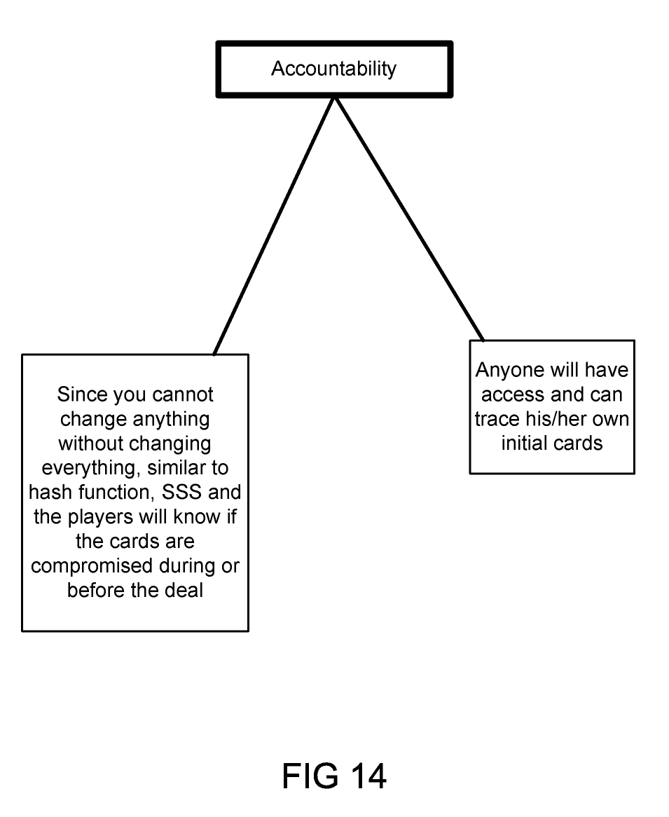

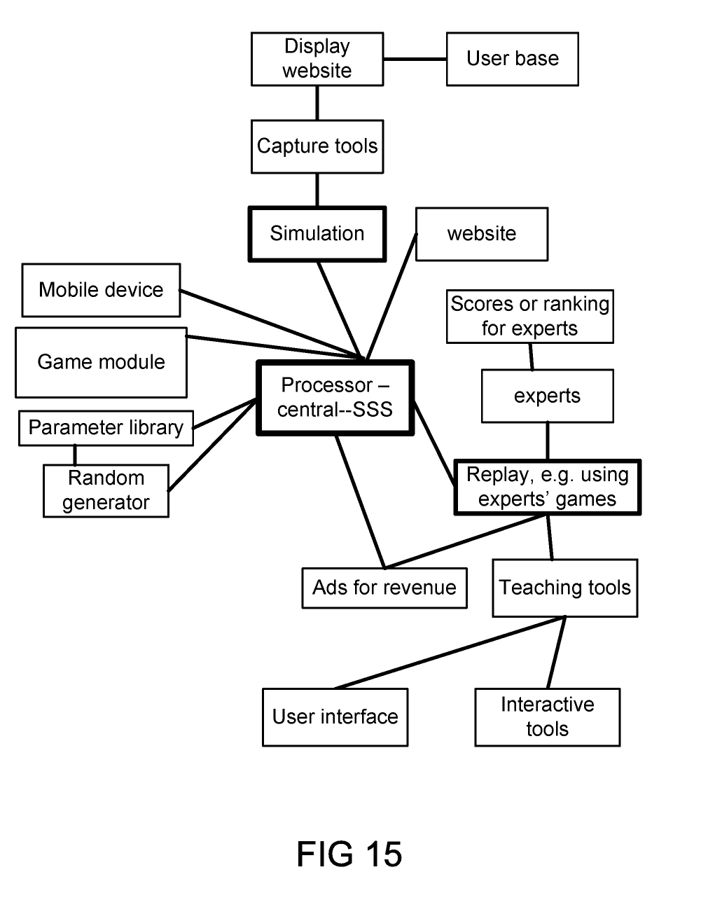

FIG. 10 is for one embodiment, as an example, for system of invention, with SSS providing service response. FIG. 11 is for one embodiment, as an example, for system of invention, with public services. FIG. 12 is for one embodiment, as an example, for system of invention, with verifiability. FIG. 13 is for one embodiment, as an example, for system of invention, with transparency. FIG. 14 is for one embodiment, as an example, for system of invention, with accountability. FIG. 15 is for one embodiment, as an example, for system of invention, with replay and simulation features.

In one embodiment, we have: A method of public verification of a gambling website or gaming event, said method comprising: an input device receiving parameters for a game of card; a processor activating a random number module, using a seed value, to generate a random parameter; a gaming module creating a virtual deck of cards; a mixing module shuffling said virtual deck of cards, using said random parameter, to produce a shuffled virtual deck of cards; assigning a unique identifier to said shuffled virtual deck of cards; a security module encrypting said shuffled virtual deck of cards; a subscriber requesting said shuffled virtual deck of cards, through a user interface, for said game of card; said processor time-stamping said shuffled virtual deck of cards; said processor storing said shuffled virtual deck of cards in a secure memory storage; said processor sending said shuffled virtual deck of cards to said subscriber, with following extra features:

auditing said shuffled virtual deck of cards.

displaying said shuffled virtual deck of cards to public at a later time.

accessing said shuffled virtual deck of cards by a player at a later time.

auditing by a casino.

auditing by a government agency.

auditing by a trusted entity.

auditing a racing event.

auditing a sport event.

auditing a fantasy sport event.

auditing a game of poker.

auditing a software game.

auditing said gambling website.

auditing said gaming event.

verifying said subscriber.

securing a communication device.

applying biometrics or private-public key technology.

applying a hash function.

obtaining a signature.

applying a block-chain on data for validation later on.

In one example, we put the cards in a block chain or series or set or ordered set, to preserve the order for verification later on. One can also get a hash function of this set or chain for verification as a single number or code, for signature, for fast verification. Of course, all set (or, e.g., cards) can be verified one-by-one, as well, for more accuracy and verification.

In one embodiment, e.g., we have the following steps and method:
Start the process
Create a virtual deck of card and give it a unique identifier
Encrypt the cards so that it is encrypted in the database
Shuffle the cards using True Random Numbers and modern version of Fisher-Yates Algorithm
Create service response by preparing the next available deck
   a. This step was fed by another step: subscriber makes a service request by sending table number, hand number, and game type (and/or casino location or ID or device ID or game ID or session ID or time info)
Timestamp the deck of cards or other parameters of the game & secure them using block-chaining
   a. Secure shuffle data warehouse
Send encrypted deck of cards to subscriber (only subscriber has the decryption key)

In one embodiment, e.g., a block chain is a distributed database that maintains a continually growing list of data records that are hardened against tampering and revision, even by the operators of the data or game or nodes.

In one embodiment, e.g., we are using Fisher-Yates shuffle algorithm, or modern version of that, or the one introduced by Richard Durstenfeld in 1964, or the one by Donald E. Knuth in “The art of computer programming”, known as “Algorithm P”. For example, in Durstenfeld's solution moves the struck numbers to the end of the list by swapping them with the last un-struck number at each iteration, to reduce the time complexity for calculations from the order of n2 to the order of n. For zero-based array, the change is as follows:

To shuffle an array of n elements (as “a”), for indices 0, . . . , (n−1), we have:

For i, from (n−1) down to 1, do:
j←random integer such that 0≦j≦i

exchange a[j] and a[i]

If the random number generator can return a random integer p≦j<q for specified parameters p and q, then we have:

To shuffle an array of n elements (as “a”), for indices 0, . . . , (n−1), we have:

For i, from 0 to (n−2), do:

j←random integer such that i≦j<n

exchange a[j] and a[i]

Thus, any of the algorithms above can be used in our system and method (or any other similar algorithm, for shuffling purposes and proper mixing of cards or other parameters).

Another embodiment is Secure Shuffle Services, which for the most part addresses the integrity of the cards and offers a verifiable and transparent method of insuring that the cards are not seen by would-be-hackers and others. However, the problem of collusion and conspiracy of two or more players at the table still remains a possibility in an on-line gambling easier than in-person setting.

In order the address the above problem, we have come up with a solution, as well. We believe the ultimate way to overcome this problem or substantially reduce the probability of this type of cheating is to play with people you do trust, such as family and friends. Therefore, aside from Secure Shuffle, we are also presenting a software module that allows each individual to host his or her own game, much the same way that people have a poker night at each others' homes.

Our software allows each person to host a virtual game, for as many as 10 friends and family members. This is available both in an App format and an on-line website. Anyone can host a game and can e-mail his guests the invitation to join this game. Our software provides the cards with Secure Shuffle and allows the host to determine the seats for everyone and will deal and monitor the game and the betting. It keeps track of the betting and will provide the end of the game summary of winning and losing to the host and everyone else.

While it is true that currently, gambling is illegal and the IRS may not like this type of unreported income in friendly home games, we think that the wave of the future is going to be such that both State and Federal Laws may change their laws and regulations so that the on-line gambling of friends and family will be allowed and possibly taxed. Our software and website will allow for taxing and reports to both the state and federal governments.

Our software and website will empower the individuals to choose his/her own gambling bodies without leaving their home and relying on casino monitoring and fees. And since the individual has hand-picked his/her playmates, the possibility of cheating through collusion is tremendously reduced.

Any variations of the above teaching are also intended to be covered by this patent application.

1. A method of public verification of a gambling website or gaming event, said method comprising:
an input device receiving parameters for a game of card;
a processor activating a random number module, using a seed value, to generate a random parameter;
a gaming module creating a virtual deck of cards;
a mixing module shuffling said virtual deck of cards, using said random parameter, to produce a shuffled virtual deck of cards;
assigning a unique identifier to said shuffled virtual deck of cards;
a security module encrypting said shuffled virtual deck of cards;
a subscriber requesting said shuffled virtual deck of cards, through a user interface, for said game of card;
said processor time-stamping said shuffled virtual deck of cards;
said processor storing said shuffled virtual deck of cards in a secure memory storage;
said processor sending said shuffled virtual deck of cards to said subscriber.

2. The method of public verification of a gambling website or gaming event as recited in claim 1, said method comprises: auditing said shuffled virtual deck of cards.

3. The method of public verification of a gambling website or gaming event as recited in claim 1, said method comprises: displaying said shuffled virtual deck of cards to public at a later time.

4. The method of public verification of a gambling website or gaming event as recited in claim 1, said method comprises: accessing said shuffled virtual deck of cards by a player at a later time.

5. The method of public verification of a gambling website or gaming event as recited in claim 1, said method comprises: auditing by a casino.

6. The method of public verification of a gambling website or gaming event as recited in claim 1, said method comprises: auditing by a government agency.

7. The method of public verification of a gambling website or gaming event as recited in claim 1, said method comprises: auditing by a trusted entity.

8. The method of public verification of a gambling website or gaming event as recited in claim 1, said method comprises: auditing a racing event.

9. The method of public verification of a gambling website or gaming event as recited in claim 1, said method comprises: auditing a sport event.

10. The method of public verification of a gambling website or gaming event as recited in claim 1, said method comprises: auditing a fantasy sport event.

11. The method of public verification of a gambling website or gaming event as recited in claim 1, said method comprises: auditing a game of poker.

12. The method of public verification of a gambling website or gaming event as recited in claim 1, said method comprises: auditing a software game.

13. The method of public verification of a gambling website or gaming event as recited in claim 1, said method comprises: auditing said gambling website.

14. The method of public verification of a gambling website or gaming event as recited in claim 1, said method comprises: auditing said gaming event.

15. The method of public verification of a gambling website or gaming event as recited in claim 1, said method comprises: verifying said subscriber.

16. The method of public verification of a gambling website or gaming event as recited in claim 1, said method comprises: securing a communication device.

17. The method of public verification of a gambling website or gaming event as recited in claim 1, said method comprises: applying biometrics or private-public key technology.

18. The method of public verification of a gambling website or gaming event as recited in claim 1, said method comprises: applying a hash function.

19. The method of public verification of a gambling website or gaming event as recited in claim 1, said method comprises: obtaining a signature.

20. The method of public verification of a gambling website or gaming event as recited in claim 1, said method comprises: applying a block-chain on data for validation later on.
